(19) United States
(12) Patent Application Publication
(10) Pub. No.: US 2021/0186064 A1
(43) Pub. Date: Jun. 24, 2021

(54) EDIBLE FILM WITH ENHANCED RELEASE EFFICIENCY OF ESSENTIAL OIL AND PREPARATION METHOD THEREOF

(71) Applicant: SOUTH CHINA AGRICULTURAL UNIVERSITY, Guangdong (CN)

(72) Inventors: Jie XIAO, Guangdong (CN); Jiyang CAI, Guangdong (CN); Xia CHEN, Guangdong (CN)

(73) Assignee: SOUTH CHINA AGRICULTURAL UNIVERSITY, Guangdong (CN)

(21) Appl. No.: 17/152,791

(22) Filed: Jan. 20, 2021

Related U.S. Application Data
(63) Continuation-in-part of application No. PCT/CN2020/100485, filed on Jul. 6, 2020.

(30) Foreign Application Priority Data
Dec. 20, 2019 (CN) 201911327654.4

(51) Int. Cl. A23L 3/3472; A23L 29/281; A23L 29/206; A23P 20/20; A23L 29/00; A23L 3/3526; A23B 7/154; B32B 9/04; B32B 33/00; B32B 37/24; B65D 65/46

(52) U.S. Cl. CPC A23L 3/3472; B32B 2439/70; A23L 29/206; A23P 20/20; A23L 29/035; A23L 3/3526; A23B 7/154; B32B 9/04; B32B 33/00; B32B 37/24; B65D 65/463; A23V 2002/00; B32B 2307/54; B32B 2307/7265; B32B 2307/7145; B32B 2309/02; B32B 2309/14; B32B 2309/105; A23L 29/284

(57) ABSTRACT

The present invention discloses an edible film with enhanced release efficiency of essential oil and a preparation method thereof. The edible film is composed of at least one blank layer and at least one essential oil-rich layer; during casting, the blank layer serves as a substrate layer and the essential oil-rich layer serves as an intermediate layer or an external layer; wherein the blank layer is composed of an alcohol-soluble protein-water-soluble protein composite film, and the essential oil-rich layer is composed of an alcohol-soluble protein-water-soluble protein composite film loading with essential oil. The present invention provides a structure and a method of divisional enrichment of essential oil, wherein the essential oil of equal mass is enriched in a certain layer of the film. Compared with the existing edible film loading with essential oil, the essential oil is loaded to the entire film matrix in the present invention.

### CROSS-REFERENCE TO RELATED APPLICATION

The present application is a continuation of PCT/CN2020/100485, filed on Jul. 6, 2020, and is related to and claims priority from China patent application no. 201911327654.4, filed on Dec. 20, 2019. The entirety of each of the above-mentioned patent applications is hereby incorporated by reference herein and made a part of this specification.

### BACKGROUND

### Technical Field

The present invention belongs to the technical field of active packaging materials, and specifically, relates to an edible film with enhanced release efficiency of essential oil and a preparation method thereof.

### Description of Related Art

In recent years, with the consumers' increased food safety and environmental awareness, the development of edible films has drawn the ever-increasing research attention. As a naturally degradable packaging material, edible films were generally developed from naturally edible biomacromolecular materials such as polysaccharides, proteins, lipids, etc. The edible film not only has the green and degradable characteristics, but also has advantages of inhibiting the microbial growth and prolonging the shelf-life of food, as a result of the loading of active substances especially those derived from natural sources. Natural active substances generally include plant essential oils, polyphenols, lysozymes, bacteriocins, etc., and particularly, the plant essential oil is widely favored by researchers for the excellent anti-microbial effect. The essential oil is directly loaded to the film and used in preservation for various foods. However, some problems still exist in the practical application of the edible film loaded with essential oil. For example, as a substance with strong volatility, loss of essential oil is severe during preparation, and how to improve the retention rate of essential oil has become an issue that draws the researchers' attention.

At present, many studies focused on reducing the loss of essential oil during preparation of films and to improve the retention rate of essential oil by various methods. For example, in Chinese patent document CN 108752610 A, loss of essential oil during preparation can be effectively reduced by adding chia seed pectin to a gelatin film; in Chinese patent document CN 109294191 A, perilla essential oil is loaded to polysaccharide of Ginkgo biloba leave to prepare a microcapsule which then is loaded to a packaging film, and the release effect of essential oil can be effectively prolonged. Chinese patent document CN108163369A discloses a multi-layer edible film with one-way moisture-resistant property and a preparation method thereof. This one-way moisture-resistant multi-layer edible film, from outside to inside, is composed of a hydrophobic external layer, a mechanical property-adjustable intermediate transition layer and a hydrophilic internal layer, wherein the hydrophobic external layer is composed of 1 to 3 hydrophobic alcohol-soluble protein layers, the hydrophilic internal layer is composed of 1 to 3 hydrophilic water-soluble protein layers, and the intermediate transition layer is composed of a mixture of an alcohol-soluble protein and a water-soluble protein. By compositing the alcohol-soluble protein with good moisture resistance property with the water-soluble protein with good water-retaining property to serve as a substrate of the multi-layer edible film, the multi-layer edible film prepared has one-way moisture resistance and good mechanical performance. However, in the previous study, the research group of the inventor found that when the essential oil was loaded to an alcohol-soluble protein-gelatin composite film in which the alcohol-soluble protein serves as a hydrophobic protein and gelatin serves as a hydrophilic protein, a phase separation structure in micro level was formed, resulting in that the essential oil was generally loaded to the alcohol-soluble protein which distributed as a self-agglomerate in the continuous phase of gelatin, and a residual rate of essential oil increased. In the system of the above-mentioned one-way moisture-resistant multi-layer edible film, release of the essential oil was subjected to two processes: the essential oil released from zein self-assembly microspheres to gelatin matrix, and then to the outside environment. However, during the release, lots of essential oil remained in the film, resulting in lower concentration of the released essential oil acting on food than the minimum inhibitory concentration (MIC). To reach the minimum inhibitory concentration, an initial additive amount of essential oil is required to be increased, which often leads to waste of essential oil and increase cost of industrial production. In addition, the release of essential oil in film is a two-way release, while the mere one-way release of essential oil acts on the food reduces the utilization rate of essential oil.

Therefore, how to improve the loading property and retention property of essential oil in the edible film via modulating its structure, and to improve the utilization rate of essential oil with less essential oil but the same or even better effect, and to improve the release efficiency of essential oil and reduce the residual rate of essential oil, has become a problem of anti-microbial edible film to be urgently solved at present, and it is of great significance for promoting the utilization rate of essential oil and decreasing the industrial production cost.

Based on our previous experiments, we found that loading sites of essential oil could be changed when preparing a multi-layer film through casting process, so as to affect the release efficiency of essential oil. There is no research reporting how the release efficiency of essential oil in edible films is affected by different loading sites of essential oil yet.

### SUMMARY

The primary objective of the present invention is to overcome the deficiencies of the prior art, and to provide an edible film with enhanced release efficiency of essential oil.

Another objective of the present invention is to provide a preparation method of the edible film with enhanced release efficiency of essential oil. This method involves a multi-layer casting process using a continuous casting machine, by modulating the number of film layers and the loading position of essential oil in films, which is able to enrich the essential oil of equal mass in a certain layer of the film to develop an essential oil-rich layer, then the release efficiency of essential oil was strongly improved. And additionally, this method is free of increasing the amount of essential oil and affecting the mechanical properties and optical properties of the film are not significantly changed. Therefore, anti-microbial effect of the edible film during application is improved, and the industrial production cost is reduced. Meanwhile, the blank layer of multi-layer film acts as a barrier layer which reduces the two-way release of essential oil in the film, allows the essential oil to be more intensively released into the fresh-keeping product, and significantly improves the release and utilization efficiencies of essential oil.

Another objective of the present invention is to provide a packaging article including the above-mentioned edible film or produced by the above-mentioned edible film.

The objectives of the present invention are achieved by the following technical solutions.

An edible film with enhanced release efficiency of essential oil, composed of at least one blank layer and at least one essential oil-rich layer; during casting, the blank layer serves as a substrate layer and the essential oil-rich layer serves as an intermediate layer or an external layer (that is, when the edible film is used as a fresh-keeping film for preserving food, there's at least one blank layer at the external side away from the food); wherein the blank layer is composed of an (alcohol-soluble protein)/(water-soluble protein) composite film, and the essential oil-rich layer is composed of an alcohol-soluble protein-water-soluble protein composite film loading with essential oil.

In the present invention, by adjusting a number of film layers and position of the essential oil-rich layer, the release efficiency of essential oil can be improved, and additionally, the mechanical properties and optical properties of the film are not significantly changed. Therefore, anti-microbial effect of the edible film during application is improved, and the industrial production cost is reduced. Meanwhile, the blank layer acts as a barrier layer which reduces the two-way release of essential oil in the film, allows the essential oil to be more intensively released into the fresh-keeping product, and significantly improves the release and utilization efficiencies of essential oil.

In some preferable embodiments therein, the edible film is composed of 1 to 4 blank layers and 1 to 4 essential oil-rich layers. The number of layers is set to comply with the requirement of industrial production. If the number of layers is too many, casting needs to be carried out for several times which decreases the industrial production efficiency and increases the industrial production cost. In addition, if the number of blank layer is too many or the number of essential oil-rich layer is too few, concentration of the essential oil loaded in the essential oil-rich layer would be too high and exceed the upper limit of loading. If the number of essential oil-rich layer is too many, volatilization loss of essential oil during casting would be increased.

In some preferable embodiments therein, the edible film has three layers which is composed of 1 to 2 blank layers and 1 to 2 essential oil-rich layers. Under such setting, the production cost is relatively low with the optimal fresh-keeping performance of film, and the highest release and utilization efficiencies of essential oil.

In some preferable embodiments therein, in the blank layer, a total mass concentration of an alcohol-soluble protein and a water-soluble protein is 16-27 wt %, wherein a mass ratio of the alcohol-soluble protein to the water-soluble protein is 1:(1.3-2.7). Preferably, the total mass concentration of the alcohol-soluble protein and the water-soluble protein is 18-22 wt %, wherein the mass ratio of the alcohol-soluble protein to the water-soluble protein is 1:(1.6-2.0). More preferably, the total mass concentration of the alcohol-soluble protein and the water-soluble protein is 20 wt %, wherein the mass ratio of the alcohol-soluble protein to the water-soluble protein is 1:2. Certain mechanical strength and transparency of the edible film are ensured by the alcohol-soluble protein and the water-soluble protein falling in the above-mentioned range, and meanwhile the edible film has a certain tenacity which would not be damaged easily when in use.

In some preferable embodiments therein, in the essential oil-rich layer, the total mass concentration of the alcohol-soluble protein and the water-soluble protein is 16-27 wt %, wherein the mass ratio of the alcohol-soluble protein to the water-soluble protein is 1:(1.3-2.7), and a concentration of the essential oil accounts for 5-18% (v/w) of a solid matter content. Preferably, the total mass concentration of the alcohol-soluble protein and the water-soluble protein is 18-22 wt %, wherein the mass ratio of the alcohol-soluble protein to the water-soluble protein is 1:(1.6-2.0), and the concentration of the essential oil accounts for 7.5-16% (v/w) of the solid matter content. More preferably, the total mass concentration of the alcohol-soluble protein and the water-soluble protein is 20 wt %, wherein the mass ratio of the alcohol-soluble protein to the water-soluble protein is 1:2. Better mechanical performance, better tensile strength and elongation, and better film-forming property are achieved in edible films prepared by the alcohol-soluble protein and the water-soluble protein falling in the above-mentioned range, and meanwhile the release efficiency and utilization efficiency are higher which is suitable for industrial production in large scale.

In the present invention, there's no particular restriction on the alcohol-soluble protein, the water-soluble protein and the lipid-soluble anti-microbial plant essential oil.

In some preferable embodiments therein, the alcohol-soluble protein is one of or a mixture of two or more of oat prolamin, zein, wheat gliadin, and kafirin. According to the present invention, suitable alcohol-soluble proteins that can be used include but are not limited to these.

In some preferable embodiments therein, the water-soluble protein is one of or a mixture of two or more of soybean protein, gelatin, whey protein, and casein. According to the present invention, suitable water-soluble proteins that can be used include but are not limited to these.

In some preferable embodiments therein, the alcohol-soluble protein is zein, and the water-soluble protein is gelatin (preferably gelatin A, i.e. type A gelatin).

In some preferable embodiments therein, the essential oil is a lipid-soluble anti-microbial plant essential oil. The lipid-soluble anti-microbial plant essential oil is selected from one of or a mixture of two or more of fingered citron essential oil, clove essential oil, thyme essential oil, lemongrass essential oil, basil essential oil, sage essential oil, rosemary essential oil, peppermint essential oil, oregano essential oil, cinnamon essential oil, tea tree essential oil, citronella essential oil, wild rose essential oil, and rose essential oil. According to the present invention, suitable anti-microbial plant essential oils that can be used include but are not limited to these.

The present invention also relates to a preparation method of the above-mentioned edible film with enhanced release efficiency of essential oil. The preparation method includes the following steps:

S1, compounding and dissolving an alcohol-soluble protein and a water-soluble protein in an acetic acid-water solution, adding a plasticizer, stirring to obtain a film-forming solution of the blank layer;

S2, dissolving an alcohol-soluble protein and a water-soluble protein in an acetic acid-water solution, stirring to complete dissolution, adding a plasticizer and an essential oil, stirring evenly to obtain a film-forming solution of the essential oil-rich layer; and

S3, casting the film-forming solutions of steps S1 and S2 to form films using a continuous casting machine, wherein during casting, first casting the film-forming solution of the blank layer, to take the blank layer as a substrate layer, and taking the essential oil-rich layer as an intermediate layer or an external layer; after a first layer of film is dried, continuing to cast the next layer of film based on the first layer of film, then continuing to dry, and by repetition, the edible film of enhancing the release efficiency of essential oil with a multi-layer film structure is obtained.

In some preferable embodiments therein, in order to form a better edible film, a cast temperature can be controlled to 40° C. to 100° C., preferably 50° C. to 80° C., and more preferably 60° C. to 70° C. A cast velocity of the continuous casting machine can also be controlled to 0.01-0.5 m/min, preferably 0.02-0.15 m/min, and more preferably 0.05-0.1 m/min.

In some preferable embodiments therein, a thickness of each blank layer is controlled to 50-500 μm; and a thickness of each essential oil-rich layer is controlled to 50-500 μm. Preferably, the thickness of each blank layer is controlled to 80-250 μm; and the thickness of each essential oil-rich layer is controlled to 80-250 μm. More preferably, the thickness of each blank layer is controlled to 100-200 μm; and the thickness of each essential oil-rich layer is controlled to 100-200 μm. Under overall consideration of the use appearance, light transmittance, water vapor permeability, tensile strength, elongation at break of the film and the release efficiency and residual rate of essential oil, a favorable mechanical strength and meanwhile acceptable tenacity of the edible film are ensured by the blank layer and the essential oil-rich layer having thicknesses falling in the above-mentioned range, and the edible film would not be damaged easily when in use.

In some preferable embodiments therein, a knife height of the continuous casting machine is set as 0.1-1 mm, preferably 0.2-0.8 mm, more preferably 0.25 mm.

In some preferable embodiments therein, the plasticizer is one or more of glycerol, water, oleic acid and polyethylene glycol; a concentration of the plasticizer in steps S1 and S2 is controlled to account for 5-20% (v/w) of a solid matter content, and preferably 8-10% (v/w).

In some preferable embodiments therein, a concentration of the acetic acid-water solution is 70% to 85%, preferably 77% to 82%, and more preferably 80%.

The present invention also relates to a packaging article including the above-mentioned edible film or produced by the above-mentioned edible film.

Compared with the prior art, the present invention has the following beneficial effects.

1. The present invention provides an edible film enriched in essential oil divisionally and enhancing the release efficiency of essential oil. Compared with that the essential oil evenly distributes throughout the film matrix, the edible film enhances the release efficiency of essential oil greatly, and reduces the use amount of essential oil and decreases the industrial production cost by concentrating the essential oil with the same mass in one or several layers of the film.

2. The mechanical properties and optical properties of the edible film prepared by the present invention which is enriched in essential oil divisionally would not be significantly changed, ensuring a good effect in application of the edible film.

3. In the edible film prepared by the present invention which is enriched in essential oil divisionally, the blank layer acts as a barrier layer which reduces the two-way release of essential oil in the edible film, allowing the essential oil to be more intensively released into the fresh-keeping product.

4. The edible film prepared by the present invention which is enriched in essential oil divisionally has a multi-layer film structure, and the adhesiveness between two layers is good without obvious separation of layers.

### BRIEF DESCRIPTION OF THE DRAWINGS

FIG. 1 shows a structural diagram of some edible films which are enriched in essential oil divisionally prepared by the embodiments of the present invention.

FIG. 2 shows release profiles of essential oil of the embodiments and comparative examples.

FIG. 3 shows the rotten rate of blueberries during the storage time packaged with the embodiments and comparative examples.

FIG. 4 shows cross-section microstructure of the embodiments and comparative examples.

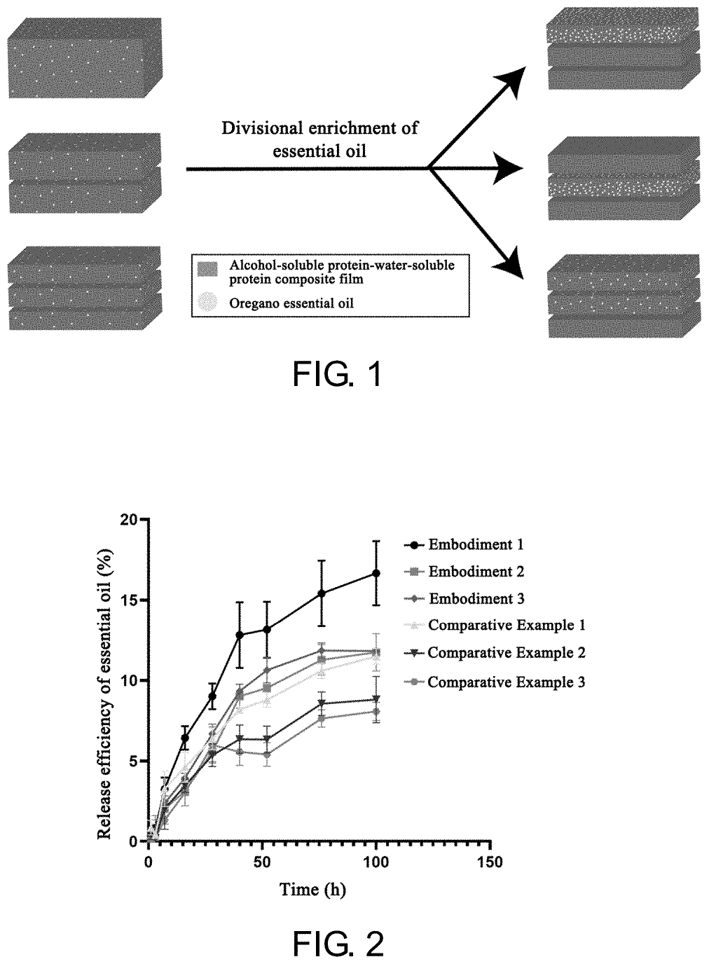

### DESCRIPTION OF THE EMBODIMENTS

The present invention is further described below in combination with the specific embodiments, but the present invention is not limited to the embodiments in any forms. Substitutions of general parameters in the implementations cannot be exhausted in the embodiments, but the present invention is not limited thereto. Any other changes, modification, substitution, combination and simplification made without departing from the spirit and principles of the present invention should be deemed as equivalent replacement and should be comprised in the scope of the present invention.

Unless specified, reagents, methods and equipment used in the present invention are conventional reagents, methods and equipment in the art.

Unless specified, reagents and materials used in the following embodiments are commercially available.

### Embodiment 1

An edible film enriched in essential oil divisionally and enhancing the release efficiency of essential oil was prepared by the following steps:

(1) preparation of a film-forming solution of a blank layer: zein and gelatin A were dissolved in an 80% (v/v) acetic acid; after stirring to complete dissolution, glycerol was added followed by magnetic stirring for 15 minutes; a total mass concentration of zein and the water-soluble protein gelatin A was controlled to 20 wt %, wherein a mass ratio of zein to the water-soluble protein gelatin A was 1:2; and a concentration of the plasticizer glycerol was controlled to account for 8% of a solid matter content;

(2) preparation of a film-forming solution of an essential oil-rich layer: zein and gelatin A were dissolved in an 80% (v/v) acetic acid; after stirring to complete dissolution, glycerol was added followed by magnetic stirring for 15 minutes; oregano essential oil was then added, followed by magnetic stirring for 1 hour; a total mass concentration of zein and the water-soluble protein gelatin A was controlled to 20 wt %, wherein a mass ratio of zein to the water-soluble protein gelatin A was 1:2, a concentration of oregano essential oil accounts for 15% (v/w) of a solid matter content; and a concentration of the plasticizer glycerol was controlled to account for 8% of the solid matter content;

(3) degasification: the above-prepared film-forming solutions were degassed ultrasonically for 5 minutes to remove the bubbles from the film-forming solutions;

(4) film-forming by multi-layer casting: the edible film was prepared by multi-layer casting with a casting machine, and parameters of the casting machine were set as follows: an oven temperature was 60° C., a cast velocity was 0.05 m/min, and a knife height was 0.25 mm;

100 mL of the film-forming solution of blank layer was poured into a trough of the casting machine, and passed through an oven to accelerate solvent evaporation; after a first layer of film was dried, 100 mL of the film-forming solution of blank layer was subsequently poured based on the first layer of film to form a second layer of film; after the second layer of film was dried, 100 mL of the film-forming solution of essential oil-rich layer was added to form a third layer of film, and finally the film was rolled up at the other end of the casting machine; and

(5) the above-prepared edible film was placed in a sealed container at a temperature of 25° C. to 30° C. with humidity of 45% to 55% for storing and testing.

### Embodiment 2

An edible film enriched in essential oil divisionally and enhancing the release efficiency of essential oil was prepared by the following steps:

(1) preparation of a film-forming solution of a blank layer: zein and gelatin A were dissolved in an 80% (v/v) acetic acid; after stirring to complete dissolution, glycerol was added followed by magnetic stirring for 15 minutes; a total mass concentration of zein and the water-soluble protein gelatin A was controlled to 20 wt %, wherein a mass ratio of zein to the water-soluble protein gelatin A was 1:2; and a concentration of the plasticizer glycerol was controlled to account for 8% of a solid matter content;

(2) preparation of a film-forming solution of an essential oil-rich layer: zein and gelatin A were dissolved in an 80% (v/v) acetic acid; after stirring to complete dissolution, glycerol was added followed by magnetic stirring for 15 minutes; oregano essential oil was then added, followed by magnetic stirring for 1 hour; a total mass concentration of zein and the water-soluble protein gelatin A was controlled to 20 wt %, wherein a mass ratio of zein to the water-soluble protein gelatin A was 1:2, a concentration of oregano essential oil accounts for 15% (v/w) of a solid matter content; and a concentration of the plasticizer glycerol was controlled to account for 8% of the solid matter content;

(3) degasification: the above-prepared film-forming solutions were degassed ultrasonically for 5 minutes to remove the bubbles from the film-forming solutions;

(4) film-forming by multi-layer casting: the edible film was prepared by multi-layer casting with a casting machine, and parameters of the casting machine were set as follows: an oven temperature was 60° C., a cast velocity was 0.05 m/min, and a knife height was 0.25 mm;

100 mL of the film-forming solution of blank layer was poured into a trough of the casting machine, and passed through an oven to accelerate solvent evaporation; after a first layer of film was dried, 100 mL of the film-forming solution of essential oil-rich layer was subsequently poured based on the first layer of film to form a second layer of film; after the second layer of film was dried, 100 mL of the film-forming solution of blank layer was added to form a third layer of film, and finally the film was rolled up at the other end of the casting machine; and

(5) the above-prepared edible film was placed in a sealed container at a temperature of 25° C. to 30° C. with humidity of 45% to 55% for storing and testing.

### Embodiment 3

An edible film enriched in essential oil divisionally and enhancing the release efficiency of essential oil was prepared by the following steps:

(1) preparation of a film-forming solution of a blank layer: zein and gelatin A were dissolved in an 80% (v/v) acetic acid; after stirring to complete dissolution, glycerol was added followed by magnetic stirring for 15 minutes; a total mass concentration of zein and the water-soluble protein gelatin A was controlled to 20 wt %, wherein a mass ratio of zein to the water-soluble protein gelatin A was 1:2; and a concentration of the plasticizer glycerol was controlled to account for 8% of a solid matter content;

(2) preparation of a film-forming solution of an essential oil-rich layer: zein and gelatin A were dissolved in an 80% (v/v) acetic acid; after stirring to complete dissolution, glycerol was added followed by magnetic stirring for 15 minutes; oregano essential oil was then added, followed by magnetic stirring for 1 hour; a total mass concentration of zein and the water-soluble protein gelatin A was controlled to 20 wt %, wherein a mass ratio of zein to the water-soluble protein gelatin A was 1:2, a concentration of oregano essential oil accounts for 7.5% (v/w) of a solid matter content; and a concentration of the plasticizer glycerol was controlled to account for 8% of the solid matter content;

(3) degasification: the above-prepared film-forming solutions were degassed ultrasonically for 5 minutes to remove the bubbles from the film-forming solutions;

(4) film-forming by multi-layer casting: the edible film was prepared by multi-layer casting with a casting machine, and parameters of the casting machine were set as follows: an oven temperature was 60° C., a cast velocity was 0.05 m/min, and a knife height was 0.25 mm;

100 mL of the film-forming solution of blank layer was poured into a trough of the casting machine, and passed through an oven to accelerate solvent evaporation; after a first layer of film was dried, 100 mL of the film-forming solution of essential oil-rich layer was subsequently poured based on the first layer of film to form a second layer of film; after the second layer of film was dried, 100 mL of the film-forming solution of essential oil-rich layer was added to form a third layer of film, and finally the film was rolled up at the other end of the casting machine; and

(5) the above-prepared edible film was placed in a sealed container at a temperature of 25° C. to 30° C. with humidity of 45% to 55% for storing and testing.

### Embodiment 4

An edible film enriched in essential oil divisionally and enhancing the release efficiency of essential oil was prepared by the following steps:

(1) preparation of a film-forming solution of a blank layer: zein and gelatin A were dissolved in an 80% (v/v) acetic acid; after stirring to complete dissolution, oleic acid was added followed by magnetic stirring for 15 minutes; a total mass concentration of zein and the water-soluble protein gelatin A was controlled to 20 wt %, wherein a mass ratio of zein to the water-soluble protein gelatin A was 1:2; and a concentration of the plasticizer glycerol was controlled to account for 8% of a solid matter content;

(2) preparation of a film-forming solution of an essential oil-rich layer: zein and gelatin A were dissolved in an 80% (v/v) acetic acid; after stirring to complete dissolution, oleic acid was added followed by magnetic stirring for 15 minutes; thyme essential oil was then added, followed by magnetic stirring for 1 hour; a total mass concentration of zein and the water-soluble protein gelatin A was controlled to 20 wt %, wherein a mass ratio of zein to the water-soluble protein gelatin A was 1:2, a concentration of thyme essential oil accounts for 15% (v/w) of a solid matter content; and a concentration of the plasticizer glycerol was controlled to account for 8% of the solid matter content;

(3) degasification: the above-prepared film-forming solutions were degassed ultrasonically for 5 minutes to remove the bubbles from the film-forming solutions;

(4) film-forming by multi-layer casting: the edible film was prepared by multi-layer casting with a casting machine, and parameters of the casting machine were set as follows: an oven temperature was 60° C., a cast velocity was 0.05 m/min, and a knife height was 0.5 mm;

100 mL of the film-forming solution of blank layer was poured into a trough of the casting machine, and passed through an oven to accelerate solvent evaporation; after a first layer of film was dried, 100 mL of the film-forming solution of essential oil-rich layer was added to form a second layer of film, and finally the film was rolled up at the other end of the casting machine; and

(5) the above-prepared edible film was placed in a sealed container at a temperature of 25° C. to 30° C. with humidity of 45% to 55% for storing.

### Embodiment 5

An edible film enriched in essential oil divisionally and enhancing the release efficiency of essential oil was prepared by the following steps:

(1) preparation of a film-forming solution of a blank layer: zein and gelatin A were dissolved in an 80% (v/v) acetic acid; after stirring to complete dissolution, glycerol was added followed by magnetic stirring for 15 minutes; a total mass concentration of zein and the water-soluble protein gelatin A was controlled to 20 wt %, wherein a mass ratio of zein to the water-soluble protein gelatin A was 1:2; and a concentration of the plasticizer glycerol was controlled to account for 8% of a solid matter content;

(2) preparation of a film-forming solution of an essential oil-rich layer: zein and gelatin A were dissolved in an 80% (v/v) acetic acid; after stirring to complete dissolution, glycerol was added followed by magnetic stirring for 15 minutes; cinnamon essential oil was then added, followed by magnetic stirring for 1 hour; a total mass concentration of zein and the water-soluble protein gelatin A was controlled to 20 wt %, wherein a mass ratio of zein to the water-soluble protein gelatin A was 1:2, a concentration of cinnamon essential oil accounts for 7.5% (v/w) of a solid matter content; and a concentration of the plasticizer glycerol was controlled to account for 8% of the solid matter content;

(3) degasification: the above-prepared film-forming solutions were degassed ultrasonically for 5 minutes to remove the bubbles from the film-forming solutions;

(4) film-forming by multi-layer casting: the edible film was prepared by multi-layer casting with a casting machine, and parameters of the casting machine were set as follows: an oven temperature was 60° C., a cast velocity was 0.05 m/min, and a knife height was 0.25 mm;

100 mL of the film-forming solution of blank layer was poured into a trough of the casting machine, and passed through an oven to accelerate solvent evaporation; after a first layer of film was dried, 100 mL of the film-forming solution of essential oil-rich layer was added to form a second layer of film; after the second layer of film was dried, 100 mL of the film-forming solution of essential oil-rich layer was added to form a third layer of film; after the third layer of film was dried, 100 mL of the film-forming solution of blank layer was added to form a fourth layer of film; and finally the film was rolled up at the other end of the casting machine; and

(5) the above-prepared edible film was placed in a sealed container at a temperature of 25° C. to 30° C. with humidity of 45% to 55% for storing.

### Embodiment 6

An edible film enriched in essential oil divisionally and enhancing the release efficiency of essential oil was prepared by the following steps:

(1) preparation of a film-forming solution of a blank layer: zein, kafirin, gelatin A, and casein were dissolved in an 80% (v/v) acetic acid; after stirring to complete dissolution, glycerol was added followed by magnetic stirring for 15 minutes; a total mass concentration of alcohol-soluble proteins (zein+kafirin) and water-soluble proteins (gelatin A+casein) was controlled to 20 wt %, wherein a mass ratio of the alcohol-soluble proteins (zein+kafirin) to the water-soluble proteins (gelatin A+casein) was 1:2; a concentration of the plasticizer glycerol was controlled to account for 8% of a solid matter content; and a mass ratio of zein to kafirin was 1:1, and a mass ratio of gelatin A to casein was 1:1;

(2) preparation of a film-forming solution of an essential oil-rich layer: zein, kafirin, gelatin A, and casein were dissolved in an 80% (v/v) acetic acid; after stirring to complete dissolution, glycerol and water were added followed by magnetic stirring for 15 minutes; fingered citron essential oil was then added, followed by magnetic stirring for 1 hour; a total mass concentration of alcohol-soluble proteins (zein+kafirin) and water-soluble proteins (gelatin A+casein) was controlled to 20 wt %, wherein a mass ratio of the alcohol-soluble proteins (zein+kafirin) to the water-soluble proteins (gelatin A+casein) was 1:2, a concentration of fingered citron essential oil accounts for 7.5% (v/w) of a solid matter content; a concentration of the plasticizers, glycerol and water (a volume ratio of glycerol to water was 1:1), was controlled to account for 8% of the solid matter content; and a mass ratio of zein to kafirin was 1:1, and a mass ratio of gelatin A to casein was 1:1;

(3) degasification: the above-prepared film-forming solutions were degassed ultrasonically for 5 minutes to remove the bubbles from the film-forming solutions;

(4) film-forming by multi-layer casting: the edible film was prepared by multi-layer casting with a casting machine, and parameters of the casting machine were set as follows: an oven temperature was 60° C., a cast velocity was 0.05 m/min, and a knife height was 0.25 mm; 100 mL of the film-forming solution of blank layer was poured into a trough of the casting machine, and passed through an oven to accelerate solvent evaporation; after a first layer of film was dried, 100 mL of the film-forming solution of essential oil-rich layer was added to form a second layer of film; after the second layer of film was dried, 100 mL of the film-forming solution of essential oil-rich layer was added to form a third layer of film; after the third layer of film was dried, 100 mL of the film-forming solution of blank layer was added to form a fourth layer of film; and finally the film was rolled up at the other end of the casting machine; and

(5) the above-prepared edible film was placed in a sealed container at a temperature of 25° C. to 30° C. with humidity of 45% to 55% for storing.

### Embodiment 7

An edible film enriched in essential oil divisionally and enhancing the release efficiency of essential oil was prepared by the following steps:

(1) preparation of a film-forming solution of a blank layer: oat prolamin and whey protein were dissolved in an 80% (v/v) acetic acid; after stirring to complete dissolution, polyethylene glycol was added followed by magnetic stirring for 15 minutes; a total mass concentration of oat prolamin and whey protein was controlled to 20 wt %, wherein a mass ratio of oat prolamin to whey protein was 1:2; and a concentration of the plasticizer polyethylene glycol was controlled to account for 8% of a solid matter content;

(2) preparation of a film-forming solution of an essential oil-rich layer: wheat gliadin and soybean protein were dissolved in an 80% (v/v) acetic acid; after stirring to complete dissolution, oleic acid was added followed by magnetic stirring for 15 minutes; sage essential oil was then added, followed by magnetic stirring for 1 hour; a total mass concentration of wheat gliadin and soybean protein was controlled to 20 wt %, wherein a mass ratio of wheat gliadin to soybean protein was 1:2, a concentration of sage essential oil accounts for 5% (v/w) of a solid matter content; and a concentration of the plasticizer oleic acid was controlled to account for 8% of the solid matter content;

(3) degasification: the above-prepared film-forming solutions were degassed ultrasonically for 5 minutes to remove the bubbles from the film-forming solutions;

(4) film-forming by multi-layer casting: the edible film was prepared by multi-layer casting with a casting machine, and parameters of the casting machine were set as follows: an oven temperature was 60° C., a cast velocity was 0.05 m/min, and a knife height was 0.25 mm; 100 mL of the film-forming solution of blank layer was poured into a trough of the casting machine, and passed through an oven to accelerate solvent evaporation; after a first layer of film was dried, 100 mL of the film-forming solution of essential oil-rich layer was added to form a second layer of film; after the second layer of film was dried, 100 mL of the film-forming solution of essential oil-rich layer was added to form a third layer of film; after the third layer of film was dried, 100 mL of the film-forming solution of blank layer was added to form a fourth layer of film; after the fourth layer of film was dried, 100 mL of the film-forming solution of blank layer was added to form a fifth layer of film; after the fifth layer of film was dried, 100 mL of the film-forming solution of essential oil-rich layer was added to form a sixth layer of film; after the sixth layer of film was dried, 100 mL of the film-forming solution of essential oil-rich layer was added to form a seventh layer of film; after the seventh layer of film was dried, 100 mL of the film-forming solution of blank layer was added to form an eighth layer of film; and finally the film was rolled up at the other end of the casting machine; and

(5) the above-prepared edible film was placed in a sealed container at a temperature of 25° C. to 30° C. with humidity of 45% to 55% for storing.

### Embodiment 8

An edible film enriched in essential oil divisionally and enhancing the release efficiency of essential oil was prepared by the following steps:

(1) preparation of a film-forming solution of a blank layer: zein and gelatin A were dissolved in an 80% (v/v) acetic acid; after stirring to complete dissolution, glycerol was added followed by magnetic stirring for 15 minutes; a total mass concentration of zein and the water-soluble protein gelatin A was controlled to 18 wt %, wherein a mass ratio of zein to the water-soluble protein gelatin A was 1:1.6; and a concentration of the plasticizer glycerol was controlled to account for 5% of a solid matter content;

(2) preparation of a film-forming solution of an essential oil-rich layer: zein and gelatin A were dissolved in an 80% (v/v) acetic acid; after stirring to complete dissolution, glycerol was added followed by magnetic stirring for 15 minutes; oregano essential oil was then added, followed by magnetic stirring for 1 hour; a total mass concentration of zein and the water-soluble protein gelatin A was controlled to 22 wt %, wherein a mass ratio of zein to the water-soluble protein gelatin A was 1:1.6, a concentration of oregano essential oil accounts for 7.5% (v/w) of a solid matter content; and a concentration of the plasticizer glycerol was controlled to account for 5% of the solid matter content;

(3) degasification: the above-prepared film-forming solutions were degassed ultrasonically for 5 minutes to remove the bubbles from the film-forming solutions;

(4) film-forming by multi-layer casting: the edible film was prepared by multi-layer casting with a casting machine, and parameters of the casting machine were set as follows: an oven temperature was 50° C., a cast velocity was 0.02 m/min, and a knife height was 0.2 mm;

100 mL of the film-forming solution of blank layer was poured into a trough of the casting machine, and passed through an oven to accelerate solvent evaporation; after a first layer of film was dried, 100 mL of the film-forming solution of blank layer was subsequently poured based on the first layer of film to form a second layer of film; after the second layer of film was dried, 100 mL of the film-forming solution of essential oil-rich layer was added to form a third layer of film, and finally the film was rolled up at the other end of the casting machine; and

(5) The above-prepared edible film was placed in a sealed container at a temperature of 25° C. to 30° C. with humidity of 45% to 55% for storing.

### Embodiment 9

An edible film enriched in essential oil divisionally and enhancing the release efficiency of essential oil was prepared by the following steps:

(1) preparation of a film-forming solution of a blank layer: zein and gelatin A were dissolved in an 80% (v/v) acetic acid; after stirring to complete dissolution, glycerol was added followed by magnetic stirring for 15 minutes; a total mass concentration of zein and the water-soluble protein gelatin A was controlled to 22 wt %, wherein a mass ratio of zein to the water-soluble protein gelatin A was 1:1.6; and a concentration of the plasticizer glycerol was controlled to account for 20% of a solid matter content;

(2) preparation of a film-forming solution of an essential oil-rich layer: zein and gelatin A were dissolved in an 80% (v/v) acetic acid; after stirring to complete dissolution, glycerol was added followed by magnetic stirring for 15 minutes; oregano essential oil was then added, followed by magnetic stirring for 1 hour; a total mass concentration of zein and the water-soluble protein gelatin A was controlled to 18 wt %, wherein a mass ratio of zein to the water-soluble protein gelatin A was 1:1.6, a concentration of oregano essential oil accounts for 16% (v/w) of a solid matter content; and a concentration of the plasticizer glycerol was controlled to account for 20% of the solid matter content;

(3) degasification: the above-prepared film-forming solutions were degassed ultrasonically for 5 minutes to remove the bubbles from the film-forming solutions;

(4) film-forming by multi-layer casting: the edible film was prepared by multi-layer casting with a casting machine, and parameters of the casting machine were set as follows: an oven temperature was 80° C., a cast velocity was 0.15 m/min, and a knife height was 0.8 mm;

100 mL of the film-forming solution of blank layer was poured into a trough of the casting machine, and passed through an oven to accelerate solvent evaporation; after a first layer of film was dried, 100 mL of the film-forming solution of blank layer was subsequently poured based on the first layer of film to form a second layer of film; after the second layer of film was dried, 100 mL of the film-forming solution of essential oil-rich layer was added to form a third layer of film, and finally the film was rolled up at the other end of the casting machine; and

(5) the above-prepared edible film was placed in a sealed container at a temperature of 25° C. to 30° C. with humidity of 45% to 55% for storing.

### Embodiment 10

An edible film enriched in essential oil divisionally and enhancing the release efficiency of essential oil was prepared by the following steps:

(1) preparation of a film-forming solution of a blank layer: zein and gelatin A were dissolved in an 80% (v/v) acetic acid; after stirring to complete dissolution, glycerol was added followed by magnetic stirring for 15 minutes; a total mass concentration of zein and the water-soluble protein gelatin A was controlled to 16 wt %, wherein a mass ratio of zein to the water-soluble protein gelatin A was 1:1.3; and a concentration of the plasticizer glycerol was controlled to account for 10% of a solid matter content;

(2) preparation of a film-forming solution of an essential oil-rich layer: zein and gelatin A were dissolved in an 80% (v/v) acetic acid; after stirring to complete dissolution, glycerol was added followed by magnetic stirring for 15 minutes; oregano essential oil was then added, followed by magnetic stirring for 1 hour; a total mass concentration of zein and the water-soluble protein gelatin A was controlled to 16 wt %, wherein a mass ratio of zein to the water-soluble protein gelatin A was 1:1.3, a concentration of oregano essential oil accounts for 5% (v/w) of a solid matter content; and a concentration of the plasticizer glycerol was controlled to account for 10% of the solid matter content;

(3) degasification: the above-prepared film-forming solutions were degassed ultrasonically for 5 minutes to remove the bubbles from the film-forming solutions;

(4) film-forming by multi-layer casting: the edible film was prepared by multi-layer casting with a casting machine, and parameters of the casting machine were set as follows: an oven temperature was 40° C., a cast velocity was 0.01 m/min, and a knife height was 0.1 mm;

100 mL of the film-forming solution of blank layer was poured into a trough of the casting machine, and passed through an oven to accelerate solvent evaporation; after a first layer of film was dried, 100 mL of the film-forming solution of blank layer was subsequently poured based on the first layer of film to form a second layer of film; after the second layer of film was dried, 100 mL of the film-forming solution of essential oil-rich layer was added to form a third layer of film, and finally the film was rolled up at the other end of the casting machine; and

(5) the above-prepared edible film was placed in a sealed container at a temperature of 25° C. to 30° C. with humidity of 45% to 55% for storing.

### Embodiment 11

An edible film enriched in essential oil divisionally and enhancing the release efficiency of essential oil was prepared by the following steps:

(1) preparation of a film-forming solution of a blank layer: zein and gelatin A were dissolved in an 80% (v/v) acetic acid; after stirring to complete dissolution, glycerol was added followed by magnetic stirring for 15 minutes; a total mass concentration of zein and the water-soluble protein gelatin A was controlled to 27 wt %, wherein a mass ratio of zein to the water-soluble protein gelatin A was 1:2.7; and a concentration of the plasticizer glycerol was controlled to account for 10% of a solid matter content;

(2) preparation of a film-forming solution of an essential oil-rich layer: zein and gelatin A were dissolved in an 80% (v/v) acetic acid; after stirring to complete dissolution, glycerol was added followed by magnetic stirring for 15 minutes; oregano essential oil was then added, followed by magnetic stirring for 1 hour; a total mass concentration of zein and the water-soluble protein gelatin A was controlled to 27 wt %, wherein a mass ratio of zein to the water-soluble protein gelatin A was 1:2.7, a concentration of oregano essential oil accounts for 18% (v/w) of a solid matter content; and a concentration of the plasticizer glycerol was controlled to account for 10% of the solid matter content;

(3) degasification: the above-prepared film-forming solutions were degassed ultrasonically for 5 minutes to remove the bubbles from the film-forming solutions;

(4) film-forming by multi-layer casting: the edible film was prepared by multi-layer casting with a casting machine, and parameters of the casting machine were set as follows: an oven temperature was 40° C., a cast velocity was 0.01 m/min, and a knife height was 1 mm;

100 mL of the film-forming solution of blank layer was poured into a trough of the casting machine, and passed through an oven to accelerate solvent evaporation; after a first layer of film was dried, 100 mL of the film-forming solution of blank layer was subsequently poured based on the first layer of film to form a second layer of film; after the second layer of film was dried, 100 mL of the film-forming solution of essential oil-rich layer was added to form a third layer of film, and finally the film was rolled up at the other end of the casting machine; and

(5) the above-prepared edible film was placed in a sealed container at a temperature of 25° C. to 30° C. with humidity of 45% to 55% for storing.

### Comparative Example 1

A conventional edible film loading with essential oil was prepared by the following steps:

(1) preparation of a film-forming solution loading with essential oil: zein and gelatin A were dissolved in an 80% (v/v) acetic acid; after stirring to complete dissolution, glycerol was added followed by magnetic stirring for 15 minutes; oregano essential oil was then added, followed by magnetic stirring for 1 hour; a total mass concentration of zein and the water-soluble protein gelatin A was controlled to 20 wt %, wherein a mass ratio of zein to the water-soluble protein gelatin A was 1:2; a concentration of oregano essential oil accounts for 5% (v/w) of a solid matter content; and a concentration of the plasticizer glycerol was controlled to account for 8% of the solid matter content;

(2) degasification: the above-prepared film-forming solution was degassed ultrasonically for 5 minutes to remove the bubbles from the film-forming solutions;

(3) film-forming by casting: the edible film was prepared with a casting machine, and parameters of the casting machine were set as follows: an oven temperature was 60° C., a cast velocity was 0.05 m/min, and a knife height was 0.75 mm; 300 mL of the film-forming solution loading with essential oil was poured into a trough of the casting machine, and passed through an oven to accelerate solvent evaporation; and finally the film was rolled up at the other end of the casting machine; and

(4) the above-prepared edible film was placed in a sealed container at a temperature of 25° C. to 30° C. with humidity of 45% to 55% for storing and testing.

### Comparative Example 2

A conventional edible film loading with an active substance prepared by a multi-layer casting process was prepared by the following steps:

(1) preparation of a film-forming solution loading with active substance: zein and gelatin A were dissolved in an 80% (v/v) acetic acid; after stirring to complete dissolution, glycerol was added followed by magnetic stirring for 15 minutes; oregano essential oil was then added, followed by magnetic stirring for 1 hour; a total mass concentration of zein and the water-soluble protein gelatin A was controlled to 20 wt %, wherein a mass ratio of zein to the water-soluble protein gelatin A was 1:2; a concentration of oregano essential oil accounts for 5% (v/w) of a solid matter content; and a concentration of the plasticizer glycerol was controlled to account for 8% of the solid matter content;

(2) degasification: the above-prepared film-forming solutions were degassed ultrasonically for 5 minutes to remove the bubbles from the film-forming solutions;

(3) film-forming by casting: the edible film was prepared by multi-layer casting with a casting machine, and parameters of the casting machine were set as follows: an oven temperature was 60° C., a cast velocity was 0.05 m/min, and a knife height was 0.375 mm;

150 mL of the film-forming solution loading with active substance was poured into a trough of the casting machine, and passed through an oven to accelerate solvent evaporation; after a first layer of film was dried, 150 mL of the film-forming solution loading with active substance was poured based on the first layer of film to form a second layer of film; and finally the film was rolled up at the other end of the casting machine; and

(4) the above-prepared edible film was placed in a sealed container at a temperature of 25° C. to 30° C. with humidity of 45% to 55% for storing and testing.

### Comparative Example 3

A conventional edible film loading with an active substance prepared by a multi-layer casting process was prepared by the following steps:

(1) preparation of a film-forming solution loading with active substance: zein and gelatin A were dissolved in an 80% (v/v) acetic acid; after stirring to complete dissolution, glycerol was added followed by magnetic stirring for 15 minutes; oregano essential oil was then added, followed by magnetic stirring for 1 hour; a total mass concentration of zein and the water-soluble protein gelatin A was controlled to 20 wt %, wherein a mass ratio of zein to the water-soluble protein gelatin A was 1:2; a concentration of oregano essential oil accounts for 5% (v/w) of a solid matter content; and a concentration of the plasticizer glycerol was controlled to account for 8% of the solid matter content;

(2) degasification: the above-prepared film-forming solutions were degassed ultrasonically for 5 minutes to remove the bubbles from the film-forming solutions;

(3) film-forming by casting: the edible film was prepared by multi-layer casting with a casting machine, and parameters of the casting machine were set as follows: an oven temperature was 60° C., a cast velocity was 0.05 m/min, and a knife height was 0.375 mm;

100 mL of the film-forming solution loading with active substance was poured into a trough of the casting machine, and passed through an oven to accelerate solvent evaporation; after a first layer of film was dried, 100 mL of the film-forming solution loading with active substance was poured based on the first layer of film to form a second layer of film; after the second layer of film was dried, 100 mL of the film-forming solution loading with active substance was added to form a third layer of film; and finally the film was rolled up at the other end of the casting machine; and

(4) the above-prepared edible film was placed in a sealed container at a temperature of 25° C. to 30° C. with humidity of 45% to 55% for storing and testing.

### Experimental Embodiment

1. Products prepared by Embodiments 1, 2, 3 and Comparative Examples 1, 2, 3 were placed in the same condition to carry out determination of release profile of oregano essential oil.

(1) By putting the product in n-hexane for continuous stirring, a release profile of oregano essential oil was determined. First, 30 mL of n-hexane was placed in a sealed serum bottle, and 1 g of the film (cut into a 5 mm×5 mm square) was put in the n-hexane. Then, the serum bottle was placed on a magnetic stirrer for continuous stirring at a rotate speed of 600 rpm to accelerate the release of essential oil from the film. At regular intervals, 0.5 mL of solution was taken out and diluted with 3 mL n-hexane, and absorbance of the diluted solution was detected at 276 nm using an ultraviolet spectrophotometer, and the concentration of essential oil was calculated according to a standard curve. Finally, a release profile of the concentration of essential oil varying with time was depicted.

(2) Test results are shown in FIG. 2.

A part of the essential oil is left in a film matrix during the release of essential oil from the film matrix to the environment, wherein the less the concentration of essential oil, the more dispersive the essential oil distributes in the film matrix, and the easier the essential oil is left in the film matrix. With the method of divisional enrichment, retention of essential oil within the film matrix can be reduced, and a displacement distance of the essential oil released from the film matrix to the environment is decreased. Besides, essential oil of high concentration can generate a stronger driving force, reducing the retention of essential oil within the film matrix. It can be seen from FIG. 2 that compared to Comparative Examples 1, 2 and 3, the release of the essential oil in Embodiments 1, 2 and 3 increased, wherein the essential oil was enriched in an external layer of the film in Embodiment 1, with a rapid-release effect; and the essential oil was enriched in an intermediate layer of the film in Embodiment 2, with a sustained-release effect, indicating that the sustained release of essential oil can be achieved by taking the essential oil-rich layer as an intermediate layer, while the rapid release of essential oil can be achieved by taking the essential oil-rich layer as an external layer.

In the comparative examples, with a number of the film layers increasing, the release efficiency of essential oil was decreased. This is because the increasing number of film layers would require increasing number of casting, a high-temperature drying time of the film was increased which raised the volatilization loss of essential oil. Therefore, the number of essential oil-rich layers should not be excessive. The addition amount of essential oil in each volume of film in the comparative examples and embodiments was equal, but a preparation method of divisional enrichment of essential oil was used, the release efficiency of essential oil was significantly enhanced. Thus, better fresh-keeping effect and reduction on industrial cost can be achieved.

2. Products prepared by Embodiments 1, 2, 3 and Comparative Examples 1, 2, 3 were placed in the same condition to determine the rotten rate of blueberries packaged with these films products during the storage time.

(1) Blueberries produced in Shandong China were chosen as the fruit object for fresh keeping. Fresh blueberries were washed clean and those with suitable size were selected, water drops on the surface were wiped off, and each culture dish was placed with 15 blueberries. The film was covered on the culture dish surface (with the upper essential oil-rich layer oriented towards fruits) and fixed with a double-side adhesive tape. Each film was subjected to three parallel experiments. All culture dishes were placed in a temperature-constant and humidity-constant oven, a temperature was controlled to 28±2° C., and relative humidity was controlled to 80%. The number of rotten blueberries was observed every two days, and a final result was calculated as the rotten rate of fruit.

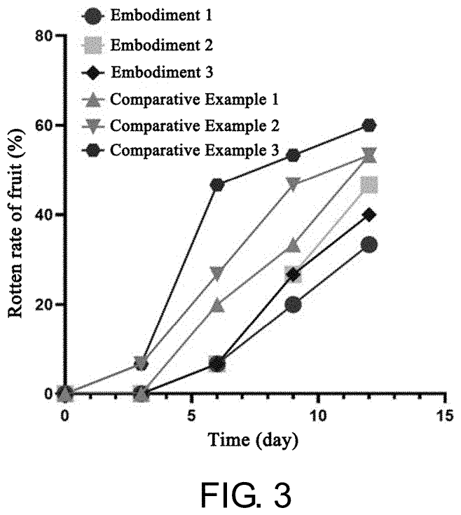

(2) Test results are shown in FIG. 3.

It can be known from the data of FIG. 3 that the rotten rate of blueberries preserved by using the films of the embodiments are all lower than those of the comparative examples. Particularly, the fresh-keeping effect of Embodiment 1 is the best. In the above determination of release profile of essential oil, although the release efficiencies of essential oil of Embodiments 2 and 3 are slightly higher than Comparative Example 1, the release of essential oil in the comparative example is a two-way release during the release of essential oil. In the practical application in fresh keeping, the essential oil acting on the objects to be preserved comes from only one direction. According to the data of FIG. 3, the fresh-keeping effect of both Embodiments 2 and 3 is obviously higher than Comparative Example 1, thus indicating that the two-way release of essential oil can be effectively reduced and anti-microbial effect of the active film can be enhanced by using the preparation method of divisional enrichment of essential oil.

3. Products prepared by Embodiments 1, 2, 3 and the comparative examples were placed in the same condition to carry out a mechanical properties test and a transparency test. The test results are shown in Table 1.

TABLE 1
Comparison of mechanical properties and transparency between different
edible films

| | Tensile strength | Elongation at | Thickness | |
|---|---|---|---|---|
| Sample | (Mpa) | break (%) | (μm) | Transparency |
| Embodiment 1 | 26.9 ± 5.08^{a} | 23.46 ± 11.58^{a} | 93.4 ± 0.66^{a} | 1.72 ± 0.35^{a} |
| Embodiment 2 | 22.09 ± 5.91^{a} | 29.57 ± 11.58^{a} | 88.13 ± 7.61^{a} | 1.35 ± 0.21^{a} |
| Embodiment 3 | 20.86 ± 6.35^{a} | 31.46 ± 6.35^{a} | 84.11 ± 2.23^{a} | 1.27 ± 0.46^{a} |
| Comparative | 21.34 ± 2.06^{a} | 28.98 ± 8.73^{a} | 93.12 ± 7.44^{a} | 1.56 ± 0.17^{a} |
| Example 1 | | | | |
| Comparative | 22.67 ± 8.09^{a} | 34.89 ± 9.57^{b} | 100.73 ± 4.92^{b} | 1.33 ± 0.21^{a} |
| Example 2 | | | | |
| Comparative | 22.23 ± 3.45^{a} | 34.6 ± 9.21^{b} | 91.6 ± 4.69^{a} | 1.30 ± 0.31^{a} |
| Example 3 | | | | |

It can be known from the data of Table 1 that there's no significant difference in the tensile strength between Embodiments 1, 2, 3 and Comparative Examples 1, 2, 3, and thus the mechanical properties of the film would not be significantly decreased by the method of divisional enrichment of essential oil. And there's no significant difference in the transparency between Embodiments 1, 2, 3 and Comparative Examples 1, 2, 3, and thus the optical properties of the film would not be affected either by the method of divisional enrichment of essential oil.

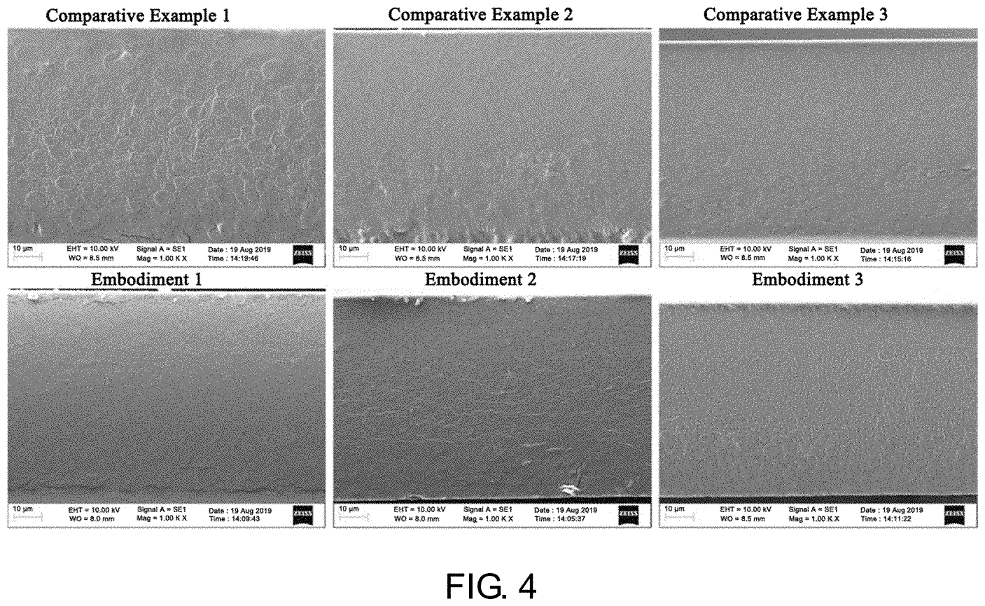

4. Products prepared by Embodiments 1, 2, 3 and Comparative Examples 1, 2, 3 were placed in the same condition to carry out observation of cross-section microstructure with a scanning electron microscope. The test result is shown in FIG. 4.

As seen from the FIG. 4, the three-layer structures in Embodiments 1, 2, 3, have good adhesiveness between layers without obvious separation of layers. This is because the solution used for preparing the three-layer film is the 80% acetic acid-water solution, when casting the film-forming solution on a previous dried film, the 80% acetic acid-water solution would re-dissolve a part of the surface of the already dried film, thus resulting in good adhesiveness between layers.

5. Products prepared by Embodiments 1 and Embodiments 4, 5, 6, 7, 8, 9, 10, 11 were placed in the same condition to carry out a test of release profile of oregano essential oil from the film, a mechanical property test and optical property test, and observation of cross-section microstructure.

It is found in the results that the products prepared by Embodiments 4, 5, 6, 7, 8, 9, 10, 11 have good adhesiveness between layers without obvious separation of layers, and the mechanical properties and transparency of the films are relatively good, meanwhile with greatly enhanced release efficiency of essential oil. Particularly, through comparison of the products prepared by Embodiments 8, 9, 10, 11 and the product prepared by Embodiment 1, in the aspect of the release efficiency of essential oil, Embodiment 1 is better than Embodiments 8 and 9, and Embodiments 8 and 9 are better than Embodiments 10 and 11.

It is stated by the applicant that the above specific implementations are preferred embodiments for the convenience of understanding the present invention, but the present invention is not limited to the above embodiments, that is, it does not mean that the present invention must rely on the above embodiments to be implemented. Those skilled in the art should understand that any improvement to the present invention, the equivalent substitution of the raw materials selected in the present invention, the addition of auxiliary components, the selection of specific methods, etc. all fall within the scope of protection and disclosure of the present invention.

What is claimed is:

1. An edible film with enhanced release efficiency of essential oil, characterized in that, the edible film is composed of at least one blank layer and at least one essential oil-rich layer; during casting, the blank layer serves as a substrate layer and the essential oil-rich layer serves as an intermediate layer or an external layer; wherein the blank layer is composed of an alcohol-soluble protein-water-soluble protein composite film, and the essential oil-rich layer is composed of an alcohol-soluble protein-water-soluble protein composite film loading with essential oil.

2. The edible film according to claim 1, wherein the edible film is composed of 1 to 4 blank layers and 1 to 4 essential oil-rich layers.

3. The edible film according to claim 1, wherein in the blank layer, a total mass concentration of an alcohol-soluble protein and a water-soluble protein is 16-27 wt %, wherein a mass ratio of the alcohol-soluble protein to the water-soluble protein is 1:(1.3-2.7).

4. The edible film according to claim 3, wherein in the blank layer, the total mass concentration of the alcohol-soluble protein and the water-soluble protein is 18-22 wt %, wherein the mass ratio of the alcohol-soluble protein to the water-soluble protein is 1:(1.6-2.0).

5. The edible film according to claim 4, wherein in the essential oil-rich layer, the total mass concentration of the alcohol-soluble protein and the water-soluble protein is 16-27 wt %, wherein the mass ratio of the alcohol-soluble protein to the water-soluble protein is 1:(1.3-2.7), and a concentration of the essential oil accounts for 5-18% (v/w) of a solid matter content.

6. The edible film according to claim 5, wherein in the essential oil-rich layer, the total mass concentration of the alcohol-soluble protein and the water-soluble protein is 18-22 wt %, wherein the mass ratio of the alcohol-soluble protein to the water-soluble protein is 1:(1.6-2.0), and the concentration of the essential oil accounts for 7.5-16% (v/w) of the solid matter content.

7. A preparation method for the edible film with enhanced release efficiency of essential oil according to claim 1, characterized in that, the preparation method comprises the following steps:
S1, compounding and dissolving an alcohol-soluble protein and a water-soluble protein in an acetic acid-water solution, adding a plasticizer, stirring to obtain a film-forming solution of the blank layer;
S2, dissolving an alcohol-soluble protein and a water-soluble protein in an acetic acid-water solution, stirring to complete dissolution, adding a plasticizer and an essential oil, stirring evenly to obtain a film-forming solution of the essential oil-rich layer; and
S3, casting the film-forming solutions of steps S1 and S2 to form films, wherein during casting, first casting the film-forming solution of the blank layer, to take the blank layer as a substrate layer, and taking the essential oil-rich layer as an intermediate layer or an external layer; after a first layer of film is dried, continuing to cast the next layer of film based on the first layer of film, then continuing to dry, and by repetition, the edible film of enhancing the release efficiency of essential oil with a multi-layer film structure is obtained.

8. The preparation method according to claim 7, wherein a cast temperature is 40° C. to 100° C., and a cast velocity is 0.01-0.5 m/min.

9. The preparation method according to claim 7, wherein a thickness of each blank layer is controlled to 50-500 μm; and a thickness of each essential oil-rich layer is controlled to 50-500 μm.

10. The preparation method according to claim 7, wherein the plasticizer is one or more of glycerol, water, oleic acid and polyethylene glycol; a concentration of the plasticizer in steps S1 and S2 is controlled to account for 5-20% (v/w) of a solid matter content.

11. A packaging article, characterized in that, the packaging article comprises or is produced by the edible film according to claim 1.

12. A preparation method for the edible film with enhanced release efficiency of essential oil according to claim 2, characterized in that, the preparation method comprises the following steps:
S1, compounding and dissolving an alcohol-soluble protein and a water-soluble protein in an acetic acid-water solution, adding a plasticizer, stirring to obtain a film-forming solution of the blank layer;
S2, dissolving an alcohol-soluble protein and a water-soluble protein in an acetic acid-water solution, stirring to complete dissolution, adding a plasticizer and an essential oil, stirring evenly to obtain a film-forming solution of the essential oil-rich layer; and
S3, casting the film-forming solutions of steps S1 and S2 to form films, wherein during casting, first casting the film-forming solution of the blank layer, to take the blank layer as a substrate layer, and taking the essential oil-rich layer as an intermediate layer or an external layer; after a first layer of film is dried, continuing to cast the next layer of film based on the first layer of film, then continuing to dry, and by repetition, the edible film of enhancing the release efficiency of essential oil with a multi-layer film structure is obtained.

13. A preparation method for the edible film with enhanced release efficiency of essential oil according to claim 3, characterized in that, the preparation method comprises the following steps:
S1, compounding and dissolving an alcohol-soluble protein and a water-soluble protein in an acetic acid-water solution, adding a plasticizer, stirring to obtain a film-forming solution of the blank layer;
S2, dissolving an alcohol-soluble protein and a water-soluble protein in an acetic acid-water solution, stirring to complete dissolution, adding a plasticizer and an essential oil, stirring evenly to obtain a film-forming solution of the essential oil-rich layer; and
S3, casting the film-forming solutions of steps S1 and S2 to form films, wherein during casting, first casting the film-forming solution of the blank layer, to take the blank layer as a substrate layer, and taking the essential oil-rich layer as an intermediate layer or an external layer; after a first layer of film is dried, continuing to cast the next layer of film based on the first layer of film, then continuing to dry, and by repetition, the edible film of enhancing the release efficiency of essential oil with a multi-layer film structure is obtained.

14. A preparation method for the edible film with enhanced release efficiency of essential oil according to claim 5, characterized in that, the preparation method comprises the following steps:
S1, compounding and dissolving an alcohol-soluble protein and a water-soluble protein in an acetic acid-water solution, adding a plasticizer, stirring to obtain a film-forming solution of the blank layer;
S2, dissolving an alcohol-soluble protein and a water-soluble protein in an acetic acid-water solution, stirring to complete dissolution, adding a plasticizer and an essential oil, stirring evenly to obtain a film-forming solution of the essential oil-rich layer; and
S3, casting the film-forming solutions of steps S1 and S2 to form films, wherein during casting, first casting the film-forming solution of the blank layer, to take the blank layer as a substrate layer, and taking the essential oil-rich layer as an intermediate layer or an external layer; after a first layer of film is dried, continuing to cast the next layer of film based on the first layer of film, then continuing to dry, and by repetition, the edible film of enhancing the release efficiency of essential oil with a multi-layer film structure is obtained.

15. A packaging article, characterized in that, the packaging article comprises or is produced by the edible film according to claim 2.

16. A packaging article, characterized in that, the packaging article comprises or is produced by the edible film according to claim 3.

17. A packaging article, characterized in that, the packaging article comprises or is produced by the edible film according to claim 5.
